(19) United States
(12) Patent Application Publication
(10) Pub. No.: US 2006/0179735 A1
(43) Pub. Date: Aug. 17, 2006

(54) Storm shutter

(76) Inventor: David M. McNelis, Palm Coast, FL (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 11/048,757

(22) Filed: Feb. 3, 2005

(51) Int. Cl. E06B 3/26

(52) U.S. Cl. 52/202

(57) ABSTRACT

A storm shutter for protecting building windows from severe weather. The storm shutter includes a panel with a slot for covering a window. A pair of retaining collars is affixed to the panel at the opposite ends of the slot. A brace is slidably secured to the panel by means of the collars. Each brace includes a pair of legs having pivotally connected inner ends. A pair of feet is hingedly to the outer ends of the legs and slidably extends through the retaining collars. A pair of shoes is affixed to the feet for gripping a window frame.

### FIELD OF THE INVENTION

The present invention relates generally to movable or removable closures for common openings in building structures.

### BACKGROUND OF THE INVENTION

Shutters have long been used to protect glass windows from damaging winds, driving rain and flying debris. Perhaps the most simple and effective storm shutters comprise rigid panels secured to building exteriors by penetrating fasteners. Unfortunately, it is often difficult and dangerous to drive the fasteners in a rising storm or at night or at the top of a ladder. Further, after a storm has past, holes in a building imparted by a shutter's fasteners must be repaired.

### SUMMARY OF THE INVENTION

In light of the problems associated with the known products for protecting windows during periods of severe weather, it is a principal object of the invention to provide a storm shutter that provides excellent protection from storms yet is easy and safe to install. The shutter requires neither tools nor prolonged instruction to put up. Installation can be handled by one person with ordinary strength.

It is another object of the present invention to provide a storm shutter that is not easily pulled from its moorings by high winds or impacts of other objects.

It is a further object of the present invention to provide a storm shutter of the type described that can be compactly stacked for storage when not in use. Thus, the storm shutter requires little room in a garage, shed or crawl space during periods of fair weather.

It is an object of the invention to provide improved elements and arrangements thereof in a storm shutter for the purposes described which is lightweight in construction, inexpensive to manufacture, and dependable in use.

Briefly, the storm shutter in accordance with this invention achieves the intended objects by featuring a panel having a pair of parallel slots. A retaining collar is affixed to the panel at each end of each slot. A pair of braces is secured to the panel by the collars. Each brace includes a pair of legs having spaced-apart apertures at their inner ends. A pivot pin is selectively extended through one of the apertures in each of the legs to connect the legs together. A pair of feet is hingedly connected to the outer ends of the legs of each brace and slidably extends through the retaining collars so that the legs can pivot forwardly relative to the feet through the slots to an unlocked position and so that the legs can pivot rearwardly to a locked position external of the slots. A pair of shoes is affixed to the feet for gripping a window frame. Finally, a pair of doors is slidably secured to the panel for closing the slots when the braces are in a locked position.

The foregoing and other objects, features and advantages of the present invention will become readily apparent upon further review of the following detailed description of the preferred embodiment as illustrated in the accompanying drawings.

### BRIEF DESCRIPTION OF THE DRAWINGS

The present invention may be more readily described with reference to the accompanying drawings, in which:

FIG. 1 is a perspective view of a storm shutter in accordance with the present invention shown secured to a window frame.

FIG. 2 is a side view of the storm shutter of FIG. 1.

FIG. 3 is a front view of the storm shutter.

FIG. 4 is an enlarged view showing details of the center portion of a brace of the storm shutter.

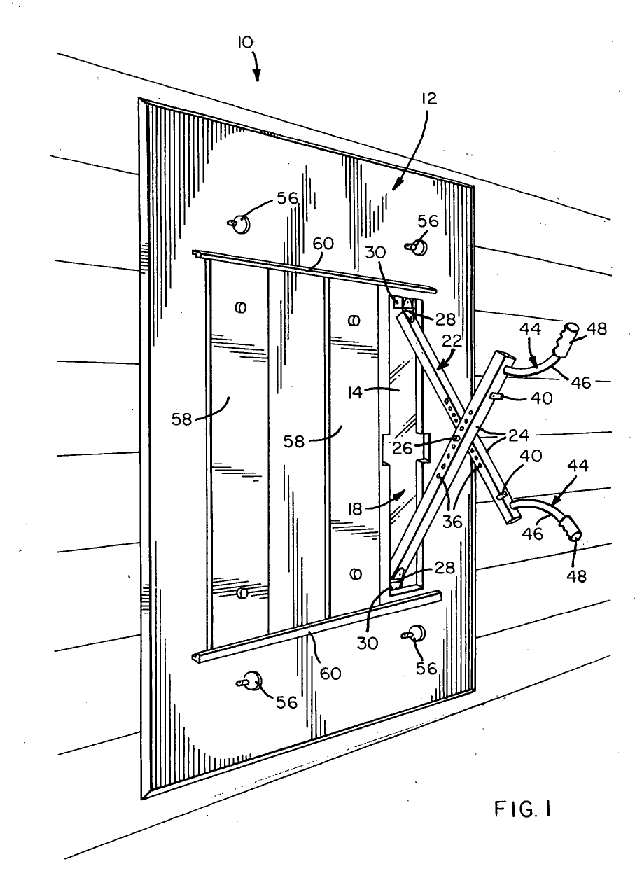

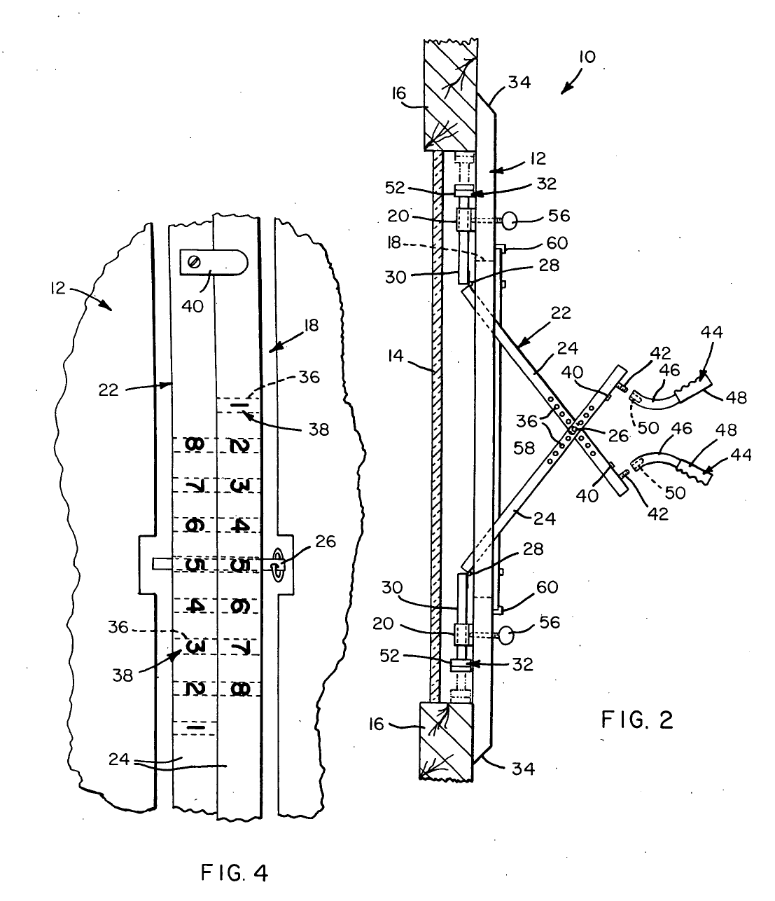

Similar reference characters denote corresponding features consistently throughout the accompanying drawings.

### DETAILED DESCRIPTION OF THE PREFERRED EMBODIMENT

Referring now to the FIGS., a storm shutter in accordance with the present invention is shown at 10. Shutter 10 includes a panel 12 sized to cover a window 14 supported by a window frame 16; A pair of parallel slots 18 is provided in panel 12 and a retaining collar 20 is affixed to the inner surface of panel 12 at each end of each of slots 18. A brace 22 is positioned in each of slots 18 and is secured to panel 12 by collars 20. Each brace 22 includes a pair of legs 24 connected together at their inner ends by a pivot pin 26. A hinge 28 connects the outer end of each leg 24 to a foot 30 that slidably extends through a collar 20. The outer end of each foot 30 is fitted with a shoe 32 for gripping window frame 16.

Panel 12 is formed of any material such as wood, plastic, and fiberglass composite that is capable of withstanding both hurricane force winds and high-speed impacts from wind-borne debris. The dimensions and shape of panel 12 are a matter of design choice, but, as most windows and window frames are rectangular in outline, panel 12 is provided with a like geometry. Further, to reduce lateral wind loads that tend to pry all shutters from their moorings, panel 12 is provided with a beveled peripheral edge 34.

Slots 18 are positioned on opposite sides of panel 12 and are vertically oriented. The length of each of slots 18 is substantially the same as the length of legs 24. The width of slots 18 is sufficient to accommodate a pair of legs 24 positioned side-by-side.

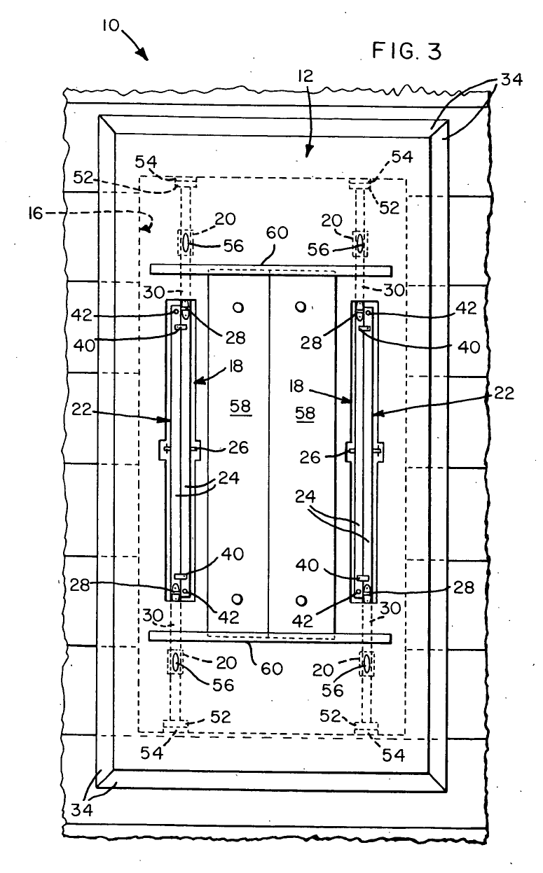

Each retaining collar 20 is a tube of square cross section sized to snugly, yet slidably, accommodate a single foot 30. As the paired legs 24 in each slot 18 are positioned side-by-side as can best be seen with reference to FIG. 3, collars 20 are laterally offset to permit braces 22 to move without binding.

Each of legs 24 is provided with a plurality of spaced-apart apertures 36 at its inner end through which a pivot pin 26 can be selectively extended to vary the lengths of braces 22. Apertures 36 are marked with indicia 38 in the form of a series of whole numbers ranging from 1-8. Indicia 38 permit a user to readily extend a pivot pin 26 through apertures 36 that are equidistant from the outer ends of paired legs 24. Thus, because all legs 24 are identical to one another in terms of their dimensions as are feet three and shoes 32, indicia 38 permit a user to easily retain pivot pin 26 midway between the ends of braces 22 and minimize difficulties in the installation of storm shutter 10.

Legs 24 are connected by hinges 28 to feet 30. Hinges 28 are so arranged that legs 24 can pivot forwardly relative to feet 30 through slots 18 to an unlocked position where the grip that shoes 32 may have upon window frame 16 is released. Hinges 28 also permit legs 24 to pivot rearwardly to a locked position where such are located adjacent the rear surface of panel 12 with legs 24 and feet 30 being in axial alignment.

To ensure that legs 24 not pivot too far in a rearward sense so as to contact and break window 14, a stop tab 40 is affixed to the inner end of each leg 24. Tabs 40 extend laterally to engage the outer end of an adjacent leg 24 when a brace 22 is set in a locked position.

Adjacent stop tab 40, an engagement pin 42 is affixed to the inner end of each leg 24. Pins 42 project forwardly from legs 24 and provide an anchorage point for handles 44 used to manipulate legs 24.

Each handle 44 comprises a rigid tube 46 having a handgrip 48 secured to one of its ends. The end of tube 46 opposite handgrip 48 is open so as to define a socket 50 for snugly, yet releasably, receiving one of pins 42. By engaging a pair of handles 44 with the pins 42 of a brace 22 and, then, pushing the handles 44 apart, legs 24 can be easily and safely moved into one of slots 18. Thus, a brace 22 can be placed in a locked position without the possibility of the fingers of a user becoming pinched.

The dimensions of feet 30 are a matter of design choice, depending mostly upon the dimensions of panel 12 and window frame 16. As shown, however, feet 30 have square cross sections that prevent feet 30 from rotating in collars 20 and, likewise, prevent braces 22 from rotating relative to panel 12. Other geometric and polygonal cross-sectional configurations, i.e., triangular, oval, hexagonal, etc., that key feet 30 within collars 20 can be substituted with equal facility for a square cross section.

Each of shoes 32 comprises a load-distributing plate 52 affixed to the outer end of one foot 30 and a resilient pad 54 secured to the outer surface of plate 52. Each plate 52 distributes the load produced by the lever action of a pair of legs 24 extending outwardly from a pivot pin 26 to ensure the strong grip of braces 22 upon window frame 16 when braces 22 are locked. Pads 54 prevent plates 52 from marring window frame 16 and provide for some variance in the dimensions of window 14 from the preset lengths of braces 22 determined by the positioning of apertures 36 in legs 24.

So that braces 22 cannot unintentionally move from a locked to an unlocked position, a plurality of thumbscrews 56 are provided to storm shutter 10. Thumbscrews 56 pass through panel 12 and the front wall of each collar 20 to engage feet 30. Thumbscrews 56 are threadably engaged with collars 20 so that, by selective rotation of thumbscrews 56, feet 30 can be secured with braces 22 in a locked position or released to permit braces 22 to travel to an unlocked position.

A pair of doors 58 is slidably secured to the front surface of panel 12 to close slots 18. As shown, doors 58 ride on L-shaped channel members 60 affixed to the top and bottom of panel 12. When desired, doors 58 are moved from their open position between slots 18 to a closed position over slots 18. When in a closed position, precipitation and the smallest pieces of wind-borne debris are prevented from passing through storm shutter 10 to window 14. Fasteners (not shown) can be employed to prevent the sliding movement of doors 58 once placed in either an open or closed position.

The use of storm shutter 10 is straightforward. First, when a severe storm is threatening, shutter 10 is removed from its storage place in a garage or similar space and placed adjacent window 14. Next, braces 22 are set in an unlocked position by pushing the inner ends of legs 24 through slots 18. Then, shutter 10 is lifted and positioned so that panel 12 covers window 14 and shoes 32 are inside window frame 16. Now, with handles 44 located on pins 42, legs 24 are pivoted into slots 18 thereby driving shoes 32 against the top and bottom of window frame 16 and locking shutter 10 adjacent window 14. Finally, by sliding doors 58 laterally to their closed position, window 14 is completely shielded from the coming storm. The entire process requires only a few minutes to complete.

Should braces 22 not immediately fit the dimensions of window 14, their lengths can be varied. To do this, pins 26 are first removed from braces 22. Then, with reference to indicia 38, correspondingly marked apertures 36 in adjacent legs of each brace 22 are aligned to increase or decrease the effective length of brace 22. Brace length is set by reinserting a pin 26 in the newly aligned apertures 36. Now, shutter 10 is installed in the normal way. Thus, a single storm shutter 10 can be used with windows 14 having a variety of dimensions.

While the invention has been described with a high degree of particularity, it will be appreciated by those skilled in the art that modifications may be made thereto. For example, shutter 10 can be provided with any number of braces 22 with greater numbers yielding a shutter having a greater resistance to detachment from a window frame. Therefore, it is to be understood that the present invention is not limited to the sole embodiment described above, but encompasses any and all embodiments within the scope of the following claims.

I claim:

1. A storm shutter, comprising:
a panel for covering a window, said panel having a slot with opposite ends;
a pair of retaining collars being affixed to said panel at said opposite ends of said slot;
a brace being secured to said panel by said collars, each brace including:
a pair of legs having pivotally connected inner ends and outer ends remote therefrom;
a pair of feet being hingedly connected to said outer ends of said legs and slidably extending through said retaining collars; and,
a pair of shoes being affixed to said feet for gripping a window frame.

2. A storm shutter, comprising:
a panel for covering a window, said panel having a pair of parallel slots each with opposite ends;
a plurality of retaining collars each being affixed to said panel at a respective one of said ends of said slots;
a pair of braces being secured to said panel by said collars, each brace including:
a pair of legs having inner ends positioned side-by-side and outer ends remote therefrom;
a pivot pin releasably connecting said inner ends of said legs together;
a pair of feet being hingedly connected to said outer ends of said legs and slidably extending through said retaining collars so that said legs can pivot forwardly relative to said feet through said slots to an unlocked position and so that said legs can pivot rearwardly to a locked position external of said slots where said legs are axially aligned with said feet; and,
a pair of shoes being affixed to said feet for gripping a window frame.

3. The storm shutter according to claim 2 wherein said panel has a beveled peripheral edge for reducing wind loads.

4. The storm shutter according to claim 2 wherein each of said retaining collars comprises a tube having a polygonal cross section and each of said feet has a corresponding cross section for preventing relative rotation.

5. The storm shutter according to claim 2 wherein each of said legs is provided with a plurality of spaced-apart apertures at said inner end thereof through which said pivot pin can be selectively extended to vary the lengths of said braces.

6. The storm shutter according to claim 5 wherein said apertures are marked with indicia for facilitating the alignment of said apertures being equidistant from the outer ends of said legs.

7. The storm shutter according to claim 2 wherein each brace further includes a pair of stop tabs each being secured to said inner end of a respective one of said legs and extending laterally therefrom to engage the outer end of another one of said legs when said brace is set in a locked position.

8. The storm shutter according to claim 2 further comprising a plurality of handles each being removably connected to the inner end of a respective one of said legs for pivoting said legs.

9. The storm shutter according to claim 2 wherein each said shoe includes a load-distributing plate being affixed to the outer end of one of said feet and a resilient pad carried by said plate.

10. The storm shutter according to claim 2 further comprising plurality of thumbscrews, each of said thumbscrews penetrating said panel and being threadably engaged with a respective one of said collars so that, by selective rotation, each of said thumbscrews can be driven into one of said feet preventing such from sliding.

11. The storm shutter according to claim 2 further comprising a pair of doors being slidably secured to said panel for closing said slots when said braces are in a locked position.

12. A storm shutter, comprising:
a panel for covering a window, said panel having a pair of parallel slots each with opposite ends;
a plurality of retaining collars each being affixed to said panel at a respective one of said ends of said slots;
a pair of braces being secured to said panel by said collars, each brace including:
a pair of legs having inner ends positioned side-by-side and outer ends remote therefrom, said legs also having a plurality of spaced-apart apertures at said inner ends thereof;
a pivot pin releasably connecting said inner ends of said legs together, said pivot pin being selectively extended through one of said apertures in each of said legs;
a pair of feet being hingedly connected to said outer ends of said legs and slidably extending through said retaining collars so that said legs can pivot forwardly relative to said feet through said slots to an unlocked position and so that said legs can pivot rearwardly to a locked position external of said slots where said legs are axially aligned with said feet; and,
a pair of shoes being affixed to said feet for gripping a window frame; and,
a pair of doors being slidably secured to said panel for closing said slots when said braces are in a locked position.
